(19) United States
(12) Patent Application Publication
(10) Pub. No.: US 2004/0228257 A1
(43) Pub. Date: Nov. 18, 2004

(54) Optical pickup

(76) Inventors: Kohji Minami, Gose-shi (JP); Tetsuo Ueyama, Nara-shi (JP); Tomoyuki Miyake, Nara-shi (JP); Yasuo Nakata, Takaichi-gun (JP)

Correspondence Address: David G. Conlin, EDWARDS & ANGELL, LLP, P.O. Box 55874, Boston, MA, 02205, US

(21) Appl. No.: 10/846,091

(22) Filed: May 14, 2004

(30) Foreign Application Priority Data
May 14, 2003 (JP) P2003-136420
Sep. 26, 2003 (JP) P2003-335944

(51) Int. Cl. G11B 7/135

(52) U.S. Cl. 369/120; 369/112.19; 369/112.21

(57) ABSTRACT

A light branching element which branches a light beam emitted from a light source and reflected on a magneto-optical recording medium is provided with four light branching portions, and three phase compensating means which give a fixed phase δM to a light beam branched by an M-th (M=2 to 4) light branching portion is disposed on paths of light beams branched by the three light branching portions except the first light branching portion of the four light branching portions. In this optical pickup, servo signals of four kinds of optical recording mediums are respectively detected using light beams detected by three or less groups of light receiving portions selected from among four groups of light receiving portions.

### BACKGROUND OF THE INVENTION

1. Field of the Invention

The present invention relates to an optical pickup which records information on a magneto-optical recording medium and/or reproduces information from a magneto-optical recording medium.

2. Description of the Related Art

In a magneto-optical recording medium that information is recorded on a recording medium by the use of both light and magnetism, so-called land/groove recording that information is recorded on and/or reproduced from both a land and a groove, or multilayer film recording that an information recording surface is made to be multilayer, is executed for the purpose of making the amount of a record of information to be large. However, the magneto-optical recording medium that the land/groove recording or the multilayer film recording is executed sometimes causes phase changes which are different from each other between polarized light beams generated by reflection of the magneto-optical recording medium, at the time of signal reproduction. For the purpose of obtaining a good state of signal reproduction even when such phase changes between the polarized light beams are caused, as disclosed in Japanese Unexamined Patent Publication JP-A 2000-306278, there is a technique for executing phase compensation by providing an optical pickup with an active element for phase compensation which is capable of controlling from outside by means of electrically controlling or the like.

FIG. 16 is a system diagram showing a structure of a conventional optical pickup 1 provided with a phase compensating element. The conventional optical pickup 1 records information on and/or reproduces information from a magneto-optical recording medium 6 on a land/groove recording system. In the conventional optical pickup 1, a light beam emitted from a semiconductor laser 2 is mostly transmitted by a polarization beam splitter 3, and the light beam is transmitted and made to be an almost parallel light beam by a collimator lens 4, and converged to an information recording layer of a magneto-optical recording medium 6 by an objective lens 5.

A polarized light beam generated by reflection of the magneto-optical recording medium 6 is transmitted again by the objective lens 5 and the collimator lens 4 and reflected by the polarization beam splitter 3, and enters a polarized light phase compensating element 7. The polarized light phase compensating element 7, which is electrically driven by a polarized light-phase compensating element driving circuit 8, applies a polarized light phase difference which varies between a land portion and a groove portion to the light beam, that is, compensates a phase difference between polarized light beams on the basis of information whether a presently reproduced track is the land portion or the groove portion, and emits the light beam. The light beam emitted from the polarized light phase compensating element 7 is polarization-split by a Wollaston prism 9, and thereafter, converged by a detecting lens 10 and detected by a reproducing sensor 11.

In the case of providing the optical pickup with the active phase compensating element as disclosed in the related art for the purpose of executing phase compensation between polarized light beams at the time of recording on and/or reproducing from plural kinds of magneto-optical recording mediums which have recording layers formed by multilayer films and in which phase differences between polarized light beams caused at the time of signal reproduction are different from each other, electric power for driving the phase compensating element is required additionally. Therefore, it is unfavorable to use the active phase compensating element as mentioned before in an apparatus for which electric power saving is important, such as a mobile apparatus, because consumed electric power increases because of electric power for driving and controlling.

Further, in the structure provided with the active phase compensating element, a servo signal and a reproduction signal (hereinafter, this reproduction signal is referred to as a magneto-optical signal) are received in a single light path, and there is a case where a great difference arises between response performance required for servo signal detection and response performance required for magneto-optical signal detection. In this case, design criteria are brought into accord with one required more strictly, and therefore, there is a problem that a restriction on the performance and size of a light receiving portion becomes strict and required tolerance for an optical system also becomes strict. Besides, connection with an external driving apparatus becomes necessary, and therefore, there is a problem that it is difficult to integrate the electrically driven phase compensating element with some of other structural elements of the optical pickup.

A method of receiving a servo signal and a magneto-optical signal in separate light paths can also be considered, however, in the case of merely using polarization split elements having the same polarization split performance and changing a branched light path for every magneto-optical recording medium to receive light, the polarization split elements must be disposed for the respective light paths branched corresponding to different reaching points of light beams after branched, and therefore, there is a problem that the number of the polarization split elements increases unnecessarily.

Further, even when it is difficult to execute effective phase compensation by merely using a polarized light film or the phase compensating element singly, an effective method for phase compensation is desired, by which it is possible to make phase compensating means effectively function and realize further increase of the quality of a magneto-optical signal.

### SUMMARY OF THE INVENTION

An object of the invention is to provide an optical pickup for recording on and/or reproducing from plural kinds of magneto-optical recording mediums which have recording layers formed by multilayer films and in which phase differences between polarized light beams caused at the time of signal reproduction are different from each other, the optical pickup being capable of reducing a stray light and releasing a restriction on a design of an optical system, such as a limitation on the size of a light receiving portion, without using electrically driven phase compensating means.

The invention provides an optical pickup for recording information on N kinds of magneto-optical recording mediums which have an information recording layer formed of multiple films and in which phase differences between polarized light beams caused at the time of signal reproduction are different from each other and/or reproducing information from the magneto-optical recording mediums, the optical pickup comprising:

a light source for emitting a light beam;

a light branching element for branching the light beam emitted from the light source and reflected by the magneto-optical recording medium, the light branching element having N light branching portions;

N groups of light receiving portions for receiving the light beams branched by the N light branching portions;

(N−1) phase compensating means which are placed on paths of light beams branched by, of the N light branching portions, remaining (N−1) light branching portions excluding an i-th light branching portion, and which provides a light beam branched by an M-th light branching portion (M=1, 2, . . . i−1, i+1, . . . N) of the remaining (N−1) light branching portions with a fixed phase δM; and

at least one polarization split element for polarization-splitting the light beams branched by the N light branching portions so as to be used for magneto-optical signal detection, wherein servo signals of the N kinds of magneto-optical recording mediums are respectively detected by the use of light beams detected by (N−1) or less groups of light receiving portions.

Further, in the invention, the phase compensating means is at least one of a phase compensating element and a polarizing film which is disposed to the light branching portion.

Still further, in the invention, the optical pickup further comprises a fixed phase compensating element which, when giving a specified fixed phase δM (M=1, 2, . . . j−1, j+1, . . . N) in the M-th branched light path of the N branched light paths, sets a difference (δM−δj) obtained by using a j-th fixed phase difference δj as a reference value, as a fixed phase, gives the fixed phase (δM−δj) to the polarizing films of all the branched light paths excluding a j-th branched light path, gives a fixed phase (−δj) in the j-th branched light path, extends over all the branched light paths, and gives a fixed phase δj.

Still further, in the invention, reflectance that each of the N light branching portions reflects for branching light is set by weighting in accordance with a modulation factor or a signal output level of a magneto-optical signal detected in each of the branched light paths of the N light branching portions.

Still further, in the invention,

the polarization split element is a diffracting element which has a plurality of diffracting portions and whose diffraction efficiency changes depending on a polarized light beam, and

the polarization split element is placed so as to extend over two or more branched light paths of the paths of the light beams branched by the N light branching portions, and so as to exist between the M-th phase compensating means and the M-th group of light receiving portions in the path of the light beam branched by the M-th light branching portion.

Still further, in the invention, the optical pickup further comprises a base portion on which the light branching element is mounted, a sub mount portion on which the light source is mounted, and at least one mirror portion which locates on the N paths of the light beams branched by the N light branching portions and guides the N branched light beams to the N groups of light receiving portions,

wherein one surface of the base portion forms a reference surface on which the sub mount portion, the N groups of light receiving portions and the mirror portion are mounted.

Still further, in the invention, the base portion is one light receiving device composed of the N groups of light receiving portions.

Still further, in the invention, the polarization split element and the phase compensating means are securely disposed to the light branching element, and the light source, the sub mount, the light branching element, the polarization split element, the mirror portion and the phase compensating means are mounted on the base portion, whereby an integral optical block member is structured.

Still further, in the invention, the polarization split element is securely disposed to the mirror portion, the phase compensating means is securely disposed to the light branching element, and the light source, the sub mount, the light branching element, the polarization split element, the mirror portion and the phase compensating means are mounted on the base portion, whereby an integral optical block member is structured.

Still further, in the invention, the optical pickup further comprises a unit base portion which has a land portion for bonding the light receiving device and the light source, a fixing member which fixes the optical block member to the unit base portion, and a protecting member which covers the optical block member,

wherein the optical block member, the unit base portion, the fixing member and the protecting member compose a light receiving and emitting unit.

Still further, in the invention, the optical pickup further comprises:

a one-half wavelength plate which is disposed on a surface of the light branching element that a light beam emitted from the light source toward the light branching portion enters, the light source being placed so as to face the light branching portion locating in the farthest position from the mounted magneto-optical recording medium;

a one-quarter wavelength plate which is disposed on a surface of the light branching element so that a light beam emitted from the light source and reflected by the light branching portion passes through; and

light reflecting means which is disposed on an opposite side to the light branching element with respect to the one-quarter wavelength plate, and which reflects light having passed through the one-quarter wavelength plate and causes the light to pass through the one-quarter wavelength plate back.

According to the invention, it is possible, without using electrical driving control means, to execute phase compensation suited to each of the N kinds of magneto-optical recording mediums which have the information recording layer made of multiple films and in which the phase differences between polarized light beams caused at the time of signal reproduction are different from each other, and to realize favorable conditions for recording and/or reproducing. Consequently, it is possible to avoid a problem that consumed electric power increases in the case of reproducing signals from the N kinds of magneto-optical recording mediums in which phase changes at the time of signal reproduction are different.

Further, since it is possible to set a branched light path of a magneto-optical signal detecting system which needs to respond at high frequencies separately and independently from a branched light path for servo signal detection, it is possible to release tolerance of a design of an optical system in the branched light path for servo signal detection, for example, it is possible to largely secure the size of the light receiving portions of each of the groups of light receiving portions disposed to the branched light path for servo signal detection which needs delicate regulation of a light receiving position.

Still further, for example, in the case of using a magneto-optical signal detecting system of a magneto-optical recording medium which reflects the largest amount of light in the N kinds of magneto-optical recording mediums, that is, which is strong to stray light noise at the time of servo signal generation, as the branched light path for servo signal detection, it is possible to prevent occurrence of a stray light which gets mixed in the branched light path of the magneto-optical signal detecting system when detecting magneto-optical signals in the remaining (N−1) kinds of magneto-optical recording mediums. Therefore, it is possible to increase the quality of the magneto-optical signals in the magneto-optical signal detecting systems in the remaining (N−1) kinds of magneto-optical recording mediums, and the most effective arrangement of the branched light paths as a measure to counter the stray light is realized.

Still further, since it is possible to execute compensation of a light path length for an arbitrary light path selected from among the each branched light paths, it is possible to reduce the size of the light receiving portions of each of the groups of light receiving portions only in a specified light path, and easily carry out a measure to reduce noise and a measure for high-speed response.

Furthermore, in the case of using the polarizing films disposed to the light branching portions as the phase compensating means, it is possible to give different phase differences to reflection light beams in the respective branching portions of the light branching element, so that each of the branching portions has a phase compensating function, and the light branching portions and the phase compensating means can be integrated. On this occasion, it is possible to use an isotropic glass material for compensation of the light path length, so that it becomes possible to compensate the light path length by merely changing the shape of the light branching element depending on the degree of compensation of the light path length, and a more compact structure can be realized.

Further, according to the invention, the optical pickup further comprises another phase compensating means which-provides all the light beams branched by the N light branching portions with the fixed phase δj. For example, in cases where the phase compensating means is composed of the polarizing films disposed to the light branching portions and the phase compensating element extending over all the branched light paths, at the time of providing the light branching portions with the polarizing films having differences in transmissivity between polarized light beams, the M-th polarizing film having desired transmissivity between polarized light beams is realized by making a relative difference (δM−δj) of a desired phase difference between polarized light beams to be a predetermined relation (giving a phase difference −δj only in a light branching portion to which a phase difference is not given finally), and adding a fixed phase δj for obtaining the desired phase difference between polarized light beams from the phase compensating element. Thus, the polarizing films giving phases (δM−δj) and disposed to the respective light branching portions and the phase compensating element giving the fixed phase δj commonly in all the branched light paths realize a phase compensating function suited to each of the plural kinds of magneto-optical recording mediums, without increase of structural elements of the optical pickup.

Still further, according to the invention, the reflectance that each of the N light branching portions reflects for branching light is set by weighting in accordance with a modulation factor or a signal output level of the magneto-optical signal detected in each of the paths of the light beams branched by the N light branching portions. Accordingly, it is possible to determine the reflectance in each branched light path, in consideration of the size of each light receiving portions of each of the groups of light receiving portions for receiving light beams branched by the light branching portions, or the modulation factor of the magneto-optical signal detected in the system branched in the light branching portion. That is to say, it is possible to determine the reflectance in consideration of not only the modulation factor of the magneto-optical signal but also a condition whether it is a branched light path which can increase the quality of the magneto-optical signal by positional regulation although the size of the light receiving portions of each of the groups of light receiving portions is small, a condition whether it is a branched light path that the size of the light receiving portions of each of the groups of light receiving portions becomes large for absorbing errors in regulation, or the like, and therefore, it is possible to obtain better conditions for reproducing the magneto-optical signals. Moreover, in the case of using a branched light path whose reflectance is low for detection of a signal of a magneto-optical recording medium whose reproduction power is small, it is also possible to compensate a decrease of the reflectance by increasing the light amount of the light source.

Still further, according to the invention, in cases where the final spot sizes of light beams vary depending on the branched light paths, or in cases where reaching positions of spots of the respective polarized light beams are differentiated, it is possible to change a grating pitch of a diffraction grating of a diffracting element serving as the polarization split element and change a branch angle, or give a wave front converting function, in each branched light path. Therefore, it is possible to guide the respective branched light beams to the N groups of light receiving portions in the most appropriate state in the respective N branched light paths.

Still further, according to the invention, the one surface of the base portion on which the light branching element is mounted forms the reference surface on which the sub mount portion, the N groups of light receiving portions and the mirror portion are mounted. Consequently, for example, it is possible to cause light to enter the group of light receiving portions by the use of the mirror portion mounted on the same mounting reference surface as the light source mounted on the sub mount and the groups of light receiving portions in the branched light path for servo signal detection. Therefore, it is possible to reduce factors in an error in an optical axis direction which is hard to correct in regulation, to elements limited to an error in the shape of the sub mount, an error in the shape of the mirror, an error in the arrangement of the groups of light receiving portions and an error in the arrangement of the light source, with the result that it is possible to decrease the error in the optical axis direction of entering positions into the groups of light receiving portions. Preferably, by defining the one light receiving device composed of the N groups of light receiving portions as the base portion, it is possible to avoid the error in the arrangement of the groups of light receiving portions of the factors in the error in the optical axis direction. This results in release of allowed tolerance in the branched light path for servo signal detection, and consequently, results in release of a restriction on an optical design in the other branched light paths. Moreover, since compensation of the light path length by the mirror portion becomes possible, it is possible to adopt various methods for compensating the light path length other than the light path length compensation by the phase compensating element and the light path length compensation by alteration of the shape of the light branching element in the case of using the polarizing films, and consequently, it becomes possible to easily compensate the light path length.

Still further, according to the invention, the polarization split element and the phase compensating means are securely disposed to the light branching element, or the polarization split element and the phase compensating means are securely disposed to the mirror portion and to the light branching element, respectively, and the polarization split element, the phase compensating means, the light source and the sub mount are mounted on the light receiving device, thereby composing the integral optical block member. Moreover, the optical block member, the unit base portion, the fixing member and the protecting member compose the light receiving and emitting unit. Since optical parts as basic elements of the optical pickup are integrated and miniaturized to be the light receiving and emitting unit in this manner, it is possible to make an error in the arrangement of the optical structural elements to be small.

Further, in cases where the polarization split element is securely disposed to the light branching element and locates on the light branching element side, it is thereby possible to secure the longest distance between a polarization split position and the group of light receiving portions, so that it is possible to make a split angle at the time of polarization split to be small. Besides, since deviation of the split angle becomes hard to occur as a result that the polarization split element and the light branching element are integrated, it is possible to reduce the amount of regulation of rotation of the mirror portion and the amount of regulation of parallel or vertical movement of the mirror portion with respect to the optical axis at the time of causing light branched by the branching portion to enter the group of light receiving portions.

Furthermore, in cases where the polarization split element is securely disposed to and integrated with the mirror portion, it is possible to change a relative polarization split angle by angle regulation accompanying regulation of the position of the mirror portion, so that it is possible to execute regulation of the position with respect to the angle by a smaller rotation angle. Therefore, at the time of servo signal regulation, it is possible to efficiently suppress deformation of a spot in mirror reflection due to rotation of the mirror portion, for example, deformation such that the size increases.

Still further, according to the invention, the one-half wavelength plate is disposed on the surface of the light branching element in which a light beam emitted from the light source toward the light branching portion enters, the one-quarter wavelength plate is disposed on the surface of the light branching element so that a light beam emitted from the light source and reflected by the light branching portion passes through, and the light reflecting means which reflects light having passed through the one-quarter wavelength plate is disposed on the opposite side to the light branching element across the one-quarter wavelength plate. Consequently, it is possible to keep a space for placing an optical element which divides a light beam in plural, such as a diffraction grating necessary for generation of a servo signal, on the light path, also on a way that the light beam emitted from the light source reaches the magneto-optical recording medium.

### BRIEF DESCRIPTION OF THE DRAWINGS

Other and further objects, features, and advantages of the invention will be more explicit from the following detailed description taken with reference to the drawings wherein:

FIG. 1A is a simplified system diagram showing a structure of an optical pickup according to a first embodiment of the invention and FIG. 1B is a front view of a light receiving device;

FIG. 2 is an enlarged view of an A section shown in FIG. 1;

FIG. 3 is a simplified system diagram showing a structure of an optical pickup according to a second embodiment of the invention;

FIG. 4A is a simplified system diagram showing a structure of an optical pickup according to a third embodiment of the invention and FIG. 4B is a front view of a light receiving device;

FIG. 5 is a simplified system diagram (a plan view) showing a structure of an optical pickup according to a fourth embodiment of the invention;

FIG. 6 is a right side view of the optical pickup shown in FIG. 5;

FIG. 7 is a downside view of the optical pickup shown in FIG. 5;

FIG. 8 is a simplified plan view showing a structure of a light receiving and emitting unit provided in an optical pickup according to a fifth embodiment of the invention;

FIG. 9 is a cross sectional view taken on cutting plane line IX-IX of FIG. 8;

FIG. 10 is a cross sectional view taken on cutting plane line X-X of FIG. 8;

FIG. 11 is a view for explaining a light path in the light receiving and emitting unit;

FIG. 12 is a simplified plan view showing a structure of a light receiving and emitting unit provided in an optical pickup according to a sixth embodiment of the invention;

FIG. 13 is a cross sectional view taken on cutting plane line XIII-XIII of FIG. 12;

FIG. 14 is a cross sectional view taken on cutting plane line XIV-XIV of FIG. 12;

FIG. 15A is a simplified system diagram showing a structure of an optical pickup according to a seventh embodiment of the invention and FIG. 15B is a front view of light receiving device; and

FIG. 16 is a system diagram showing a structure of a conventional optical pickup which is provided with a phase compensating element.

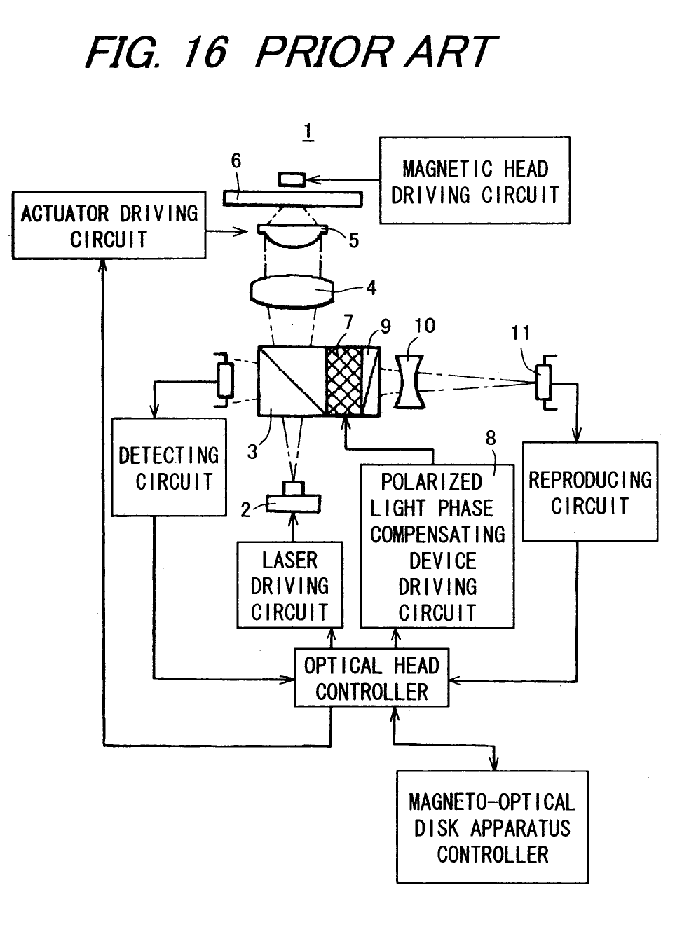

### DETAILED DESCRIPTION

Now referring to the drawings, preferred embodiments of the invention are described below.

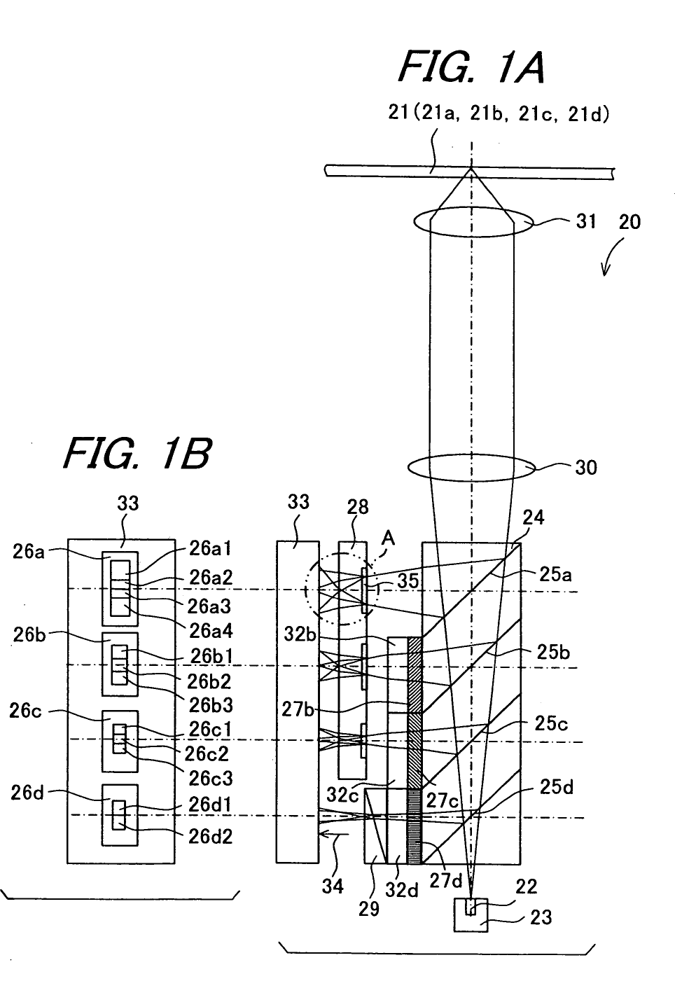

FIG. 1A is a simplified system diagram showing a structure of an optical pickup 20 according to a first embodiment of the invention. The optical pickup 20 is an apparatus for recording information on and/or reproducing information from plural kinds of magneto-optical recording mediums 21 (four kinds of 21a, 21b, 21c and 21d in the embodiment) which have an information recording layer formed of multiple films and in which phase differences between polarized light beams caused at the time of signal reproduction are different from each other.

The optical pickup 20 comprises a light source 22, a sub mount 23, a light branching element 24, four groups of light receiving portions 26a, 26b, 26c and 26d, three phase compensating means 27b, 27c and 27d, two of a first and second polarization split elements 28 and 29, a collimator lens 30 and an objective lens 31. The light source 22 emits a light beam. The light source 22 is mounted on the sub mount 23. The light branching element 24 branches a light beam emitted from the light source 22 and reflected by the magneto-optical recording medium 21 and has four light branching portions 25a, 25b, 25c and 25d. The four groups of light receiving portions 26a, 26b, 26c and 26d receive the light beams branched by the four light branching portions 25a, 25b, 25c and 25d. The three phase compensating means 27b, 27c and 27d are placed on paths of light beams branched by, of the four light branching portions 25a, 25b, 25c and 25d, the remaining three light branching portions 25b, 25c and 25d excluding the first light branching portion 25a, and give a fixed phase 6M to a light beam branched by an M-th (M=2, 3, 4) light branching portion of the remaining three light branching portions 25b, 25c and 25d. The two of first and second polarization split elements 28 and 29 polarization-split light beams branched by the four light branching portions 25a, 25b, 25c and 25d so as to be used for detection of magneto-optical signals. The collimator lens 30 makes a light beam emitted from the light branching element 24 to be an almost parallel light beam. The objective lens 31 converges a light beam transmitted by the collimator lens 30 on the information recording layer of the magneto-optical recording medium 21.

The light source 22 is a semiconductor laser, for example. The sub mount 23 is a supporting member provided with a function of supporting the light source 22, and further, a function of radiating heat generated from the light source 22. The structure of the light source 22 is not restricted to a structure such that it is supported by the sub mount 23, and may be another structure.

The light branching portions 25a, 25b, 25c and 25d provided in the light branching element 24 transmit the light beam emitted from the light source 22 toward the magneto-optical recording medium 21 (however, they may be structured to reflect part of the light beam), reflect part of a light beam reflected by the magneto-optical recording medium 21, and transmit the rest (however, only the light branching portion 25d may be structured to reflect the entire reflection light beam), thereby branching the light beam.

The phase compensating means 27b, 27c and 27d disposed on the paths of the light beams branched by the second, third and fourth light branching portions 25b, 25c and 25d as mentioned above, as well as between the aforementioned light branching portions and the first and second polarization split elements 28 and 29 are phase compensating elements in the embodiment.

Here, an example of the phase compensating element is a element structured by bonding birefringent materials in a manner that crystal axes are mutually inclined so as to cause a predetermined fixed phase between polarized light beams (i.e., so as to give the fixed phase), a element in which a birefringent film having thickness such that a predetermined fixed phase difference is caused between polarized light beams is bonded on isotropic glass, or the like.

The phase compensating element 27b gives a fixed phase δ2 to the light beam branched by the second light branching portion 25b, the phase compensating element 27c gives a fixed phase δ3 to the light beam branched by the third light branching portion 25c, and the phase compensating element 27d gives a fixed phase δ4 to the light beam branched by the fourth light branching portion 25d, whereby phase compensation is executed, that is, a phase difference between polarized light beams is compensated.

The light beams phase-compensated by the respective phase compensating elements 27b, 27c and 27d are transmitted by cover glasses 32b, 32c and 32d disposed between the respective phase compensating elements 27b, 27c and 27d and the first and second polarization split elements 28 and 29, and thereafter, enter the first and second polarization split elements 28 and 29. The cover glasses 32b, 32c and 32d are regulating members which regulate so that an actual light path lengths of the respective light beams branched by the light branching portions 25b, 25c and 25d and received by the groups of light receiving portions 26b, 26c and 26d, and an actual light path length of the light beam branched by the light branching portion 25a received by the group of light receiving portions 26a become substantially equal. As the cover glasses 32b, 32c and 32d, such members that have refraction indices suited to the respective branched light beams are appropriately selected in accordance with an object to make the actual light path lengths to be substantially equal.

As the polarization split elements, a polarizing hologram or a birefringent prism or the like can be appropriately selected and used according to polarization split angles by the polarization split elements and an arrangement relation thereof, and they may be used singly or in combination. In the embodiment, a polarizing hologram is used as the first polarization split element 28, and a birefringent prism is used as the second polarization split element 29. The first and second polarization split elements 28 and 29 polarization-split the branched light beams used for detection of the magneto-optical signals, and cause the light beams to be received by the groups of light receiving portions 26a, 26b, 26c and 26d.

The four groups of light receiving portions 26a, 26b, 26c and 26d are mounted on one substrate, whereby one light receiving device 33 is composed. FIG. 1B shows the light receiving device 33 taken from a direction of an arrow 34 in FIG. 1A. That is, FIG. 1B is a front view of the light receiving device 33. The respective groups of light receiving portions are formed so that the plural groups of light receiving portions are securely disposed to one base, and in the embodiment, the first group of light receiving portions 26a is composed of four light receiving portions 26a1, 26a2, 26a3 and 26a4. The second group of light receiving portions 26b is composed of three light receiving portions 26b1, 26b2 and 26b3. The third group of light receiving portions 26c is composed of three light receiving portions 26c1, 26c2 and 26c3. The fourth group of light receiving portions 26d is composed of two light receiving portions 26d1 and 26d2. Each of the light receiving portions, which is the minimum unit for composing the light receiving device 33, is a photoelectric converting device such as a photodiode.

In the optical pickup 20 structured as described above, reproduction of the magneto-optical signals recorded on the four different kinds of magneto-optical recording mediums 21a, 21b, 21c and 21d is executed in the following manner. In the case of reproducing from the magneto-optical recording medium 21b that generates a phase difference between polarized light beams corresponding to the phase δ2 phase-compensated by the phase compensating element 27b at the time of signal reproduction, signal reproduction is executed by the use of the groups of light receiving portions 26b. In the case of reproducing from the magneto-optical recording medium 21c that generates a phase difference between polarized light beams corresponding to the phase δ3 phase-compensated by the phase compensating element 27c at the time of signal reproduction, signal reproduction is executed by the use of the groups of light receiving portions 26c. In the case of reproducing from the magneto-optical recording medium 21d that generates a phase difference between polarized light beams corresponding to the phase δ4 phase-compensated by the phase compensating element 27d at the time of signal reproduction, signal reproduction is executed by the use of the groups of light receiving portions 26d. Moreover, in the case of reproducing from the magneto-optical recording medium 21a that does not generate a phase difference between polarized light beams, signal reproduction is executed by the use of the group of light receiving portions 26a.

According to such a signal reproduction method, it becomes unnecessary to use phase compensating means electrically driven to switch the amount of phase compensation every time a magneto-optical recording medium is replaced with one of another kind, and therefore, it is possible to prevent increase of the amount of consumed electric power. This effect is common in all embodiments described below.

Further, in the case of executing signal reproduction from any kind of magneto-optical recording medium, servo signal detection is executed by the use of a light beam entering the group of light receiving portions 26a that the size of the light receiving portion composing the group of light receiving portions is the largest, whereby regulation of a light path for guiding the branched light beam from the branch portion 25a to the group of light receiving portions 26a for servo signal detection is facilitated. Consequently, for example, in cases where a measure to reduce noise and a high-speed response are required at the time of reproducing the magneto-optical signal from the magneto-optical recording medium 21c, it is possible to reduce or eliminate complicatedness of a servo regulating operation, so that it is possible to appropriately regulate the light path length and reduce the sizes of the respective light receiving portions composing the groups of light receiving portions such as the group of light receiving portions 26c.

Furthermore, in the case of using a magneto-optical signal detecting system of a magneto-optical recording medium that an amount of reflected light is the largest of the four kinds of magneto-optical recording mediums, that is, which is strong to stray light noise at the time of servo signal generation, as a branched light path for servo signal detection, it is possible to prevent occurrence of a stray light which gets mixed in the branched light path of the magneto-optical signal detecting system when detecting magneto-optical signals in the remaining three kinds of magneto-optical recording mediums. Therefore, it is possible to increase the quality of the magneto-optical signals in the magneto-optical signal detecting systems in the remaining three kinds of magneto-optical recording mediums, and the most effective arrangement of the branched light paths is realized as a measure to counter the stray light.

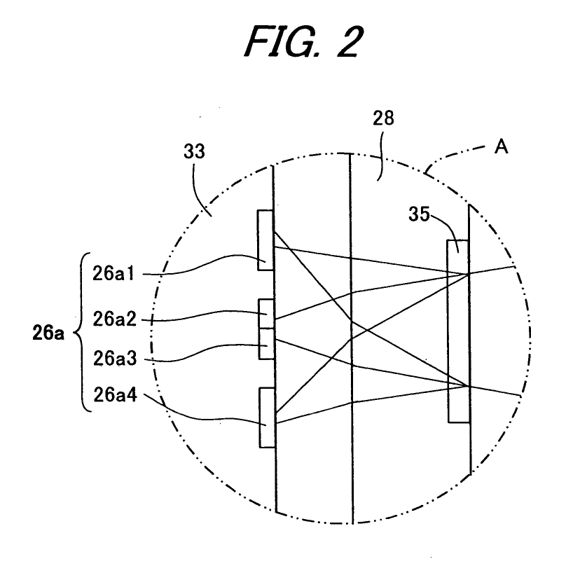

Below, servo signal detection and magneto-optical signal detection will be described using the group of light receiving portions 26a as an example. FIG. 2 is an enlarged view of an A section shown in FIG. 1. Firstly, the magneto-optical signal will be described. A diffracting portion 35 of a polarizing hologram serving as the first polarization split element 28 is placed on the path of the light beam branched by the light branching portion 25a of the light branching element 24. Light beams polarization-split by the diffracting portion 35 are almost equally received by the two light receiving portions 26a1 and 26a4 and the two light receiving portions 26a2 and 26a3 of the group of light receiving portions 26a, with the result that the magneto-optical signals are obtained from differential outputs thereof. Next, the servo signal will be described. The light beams polarization-split by the diffracting portion 35 are received by the light receiving portions 26a2 and 26a3, with the result that tracking error signals (abbreviated as TES) by a push-pull method are obtained from differential outputs thereof, and focus error signals (abbreviated as FES) by a spot size method are obtained from outputs of the light receiving portions 26a1 and 26a4.

Here, the diffracting portion 35 in the embodiment has a function of changing a focal position with respect to the path of the light beam entering the light receiving portion 26a1. Consequently, an entering point with respect to the light receiving portion 26a1 in the light path to the light receiving portion 26a1 exists on a NEAR side from a true focal position, whereas an entering point with respect to the light receiving portion 26a4 in the light path to the light receiving portion 26a4 exists on a FAR side from a true focal position. Therefore, it becomes possible to detect the FES by the spot size method regarding as a focusing point in cases where spot sizes in the respective light receiving portions in the entering light path into the light receiving portion 26a1 and the entering light path into the light receiving portion 26a4 are equal.

Regarding the servo signal, it is also possible to obtain the FES by the spot size method by enlarging the sizes of the respective light receiving portions composing the group of light receiving portions 26c, and using light beams entering the light receiving portions 26a2 and 26a3 in the middle of the group of light receiving portions 26a and light beams entering the light receiving portion 26c2 in the middle of the group of light receiving portions 26c.

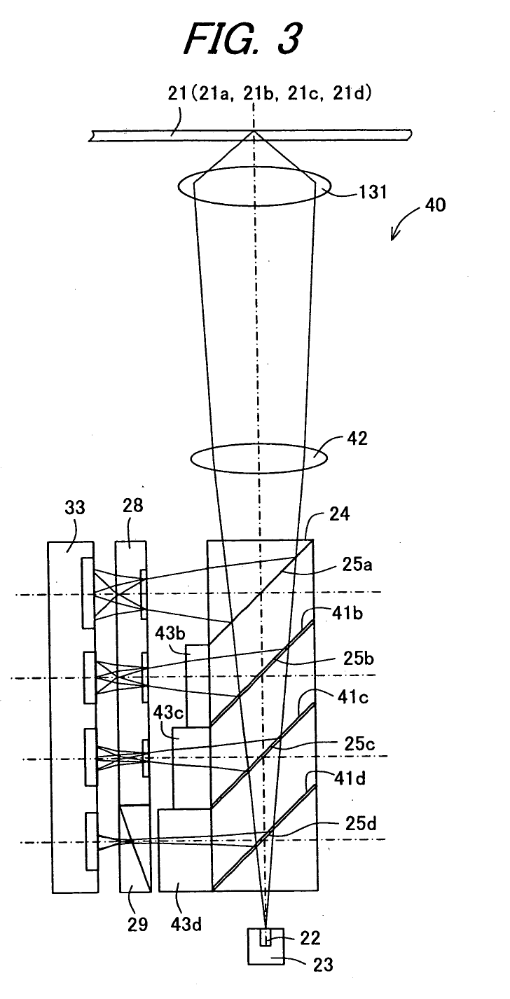

FIG. 3 is a simplified system diagram showing a structure of an optical pickup 40 according to a second embodiment of the invention. Since the optical pickup 40 of the embodiment is similar to the optical pickup 20 of the first embodiment, corresponding portions will be denoted by the same reference numerals and a description thereof will be omitted.

What should be noted in the optical pickup 40 of the embodiment is that the phase compensating means is formed by polarizing films 41b, 41c and 41d disposed to the light branching portions 25b, 25c and 25d, respectively. Moreover, a light beam emitted from the light branching element 24 toward the magneto-optical recording medium 21 is made to be of low NA (Numerical Aperture) by a semi-finite lens 42, and thereafter, converged onto the information recording surface of the magneto-optical recording medium 21 by an objective lens 131 of a different kind from that used in the first embodiment.

Here, the polarizing films 41b, 41c and 41d can be structured by dielectric multilayer films. There are various structures of the dielectric multilayer films, and there is a method of obtaining a multilayer film by using three kinds of dielectric materials and selecting refraction indices of the respective dielectric materials so that a Brewster angle on a film boundary between two of the dielectric materials becomes close to 45 degrees of an incident angle thereof. Since only one polarized light beam that a polarization plane is orthogonal has a Brewster angle in this case, such a phenomenon occurs in the multilayer film that the one polarized light beam is mostly transmitted and the other is reflected, which means that reflection positions in the multilayer film change depending on polarized light beams, and a phase difference is made between polarized light beams. By using this phase difference, it is possible to execute phase compensation.

In the optical pickup 40 structured as described above, the magneto-optical signals recorded on the four different kinds of magneto-optical recording mediums 21a, 21b, 21c and 21d are reproduced in the following manner. In the case of reproducing the magneto-optical recording medium 21b that causes a phase difference between polarized light beams corresponding to the phase δ2 phase-compensated by the polarizing film 41b at the time of signal reproduction, signal reproduction is executed by the use of the group of light receiving portions 26b. In the case of reproducing the magneto-optical recording medium 21c that causes a phase difference between polarized light beams corresponding to the phase δ3 phase-compensated by the polarizing film 41c at the time of signal reproduction, signal reproduction is executed by the use of the group of light receiving portions 26c. In the case of reproducing from the magneto-optical recording medium 21d that causes a phase difference between polarized light beams corresponding to the phase δ4 phase-compensated by the polarizing film 41d at the time of signal reproduction, signal reproduction is executed by the use of the group of light receiving portions 26d. Moreover, in the case of reproducing the magneto-optical recording medium 21a that does not generate a phase difference between polarized light beams, signal reproduction is executed by the use of the group of light receiving portions 26a.

The optical pickup 40 of the embodiment can achieve the same effect as the optical pickup 20 of the first embodiment. Moreover, in the case of using the polarizing films as the phase compensating means, it becomes possible to use not a birefringent material but a simple isotropic glass material for regulation of the actual light path lengths after phase compensation. In the optical pickup 40 of the embodiment, isotropic glass members 43b, 43c and 43d which have different light transmission thicknesses are disposed between the polarizing films 41b, 41c and 41d and the first and second polarization split elements 28 and 29, whereby the true light path lengths are regulated.

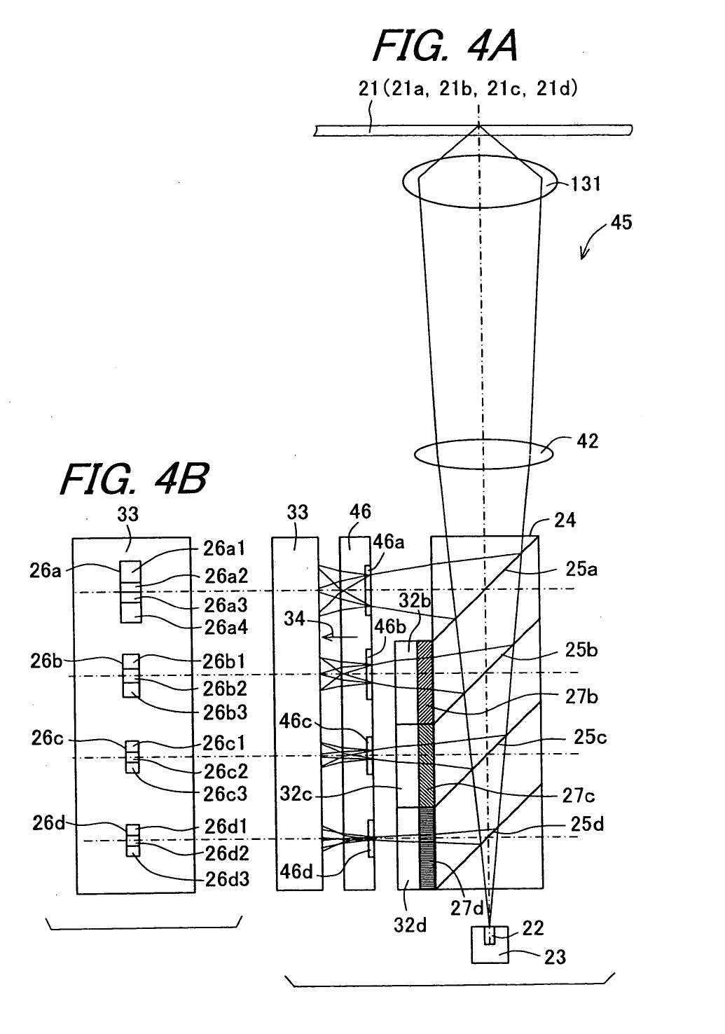

FIG. 4A is a simplified system diagram showing a structure of an optical pickup 45 according to a third embodiment of the invention. FIG. 4B is a front view of the light receiving device 33. Since the optical pickup 45 of the embodiment is similar to the optical pickup 20 of the first embodiment, corresponding portions will be denoted by the same reference numerals and a description thereof will be omitted.

What should be noted in the optical pickup 45 of the embodiment is that a single polarization split element 46 is provided and four diffracting portions 46a, 46b, 46c and 46d are formed in the polarization split element 46 made by a polarizing hologram. The periods of gratings of the four diffracting portions 46a, 46b, 46c and 46d formed in the polarization split element 46 can be determined such that diffraction angles become different from each other.

In the optical pickup 45, distances between the light branching element 24 and the groups of light receiving portions 26a, 26b, 26c and 26d are fixed. Therefore, for example, in the case of detecting a servo signal by the spot size method in the group of light receiving portions, the group of light receiving portions is caused to receive a light beam so that a defocus point is on the group of light receiving portions, with the result that the sizes of beam spots are different between the group of light receiving portions used for servo signal detection and the group of light receiving portions not used for servo signal detection, and the minimum sizes required for the respective light receiving portions composing the group of light receiving portions vary depending on the groups of light receiving portions. Since the groups of light receiving portions 26a, 26b, 26c and 26d also detect the magneto-optical signals, an interval between the light receiving groups is determined in accordance with the sizes of the groups of light receiving portions, and it is required to set an entering position in accordance with the sizes of the groups of light receiving portions and the interval between the groups of light receiving portions. The entering positions of light beams with respect to the groups of light receiving portions 26a, 26b, 26c and 26d is determined by the diffraction angles by the respective diffracting portions 46a, 46b, 46c and 46d formed in the polarization split element 46.

By using the polarization split element 46 made by a polarizing hologram and provided with the four diffracting portions 46a, 46b, 46c and 46d as described above, it is possible to easily change the diffraction angles by the respective diffracting portions.

Furthermore, it is also possible to execute detection by the spot size method or the like using two light paths, so that it becomes possible to, for example, use light paths reaching the light receiving portion 26a2 and the light receiving portion 26a3 (converge in the rear of the light receiving surfaces) and a light path reaching the light receiving portion 26d2 (converge in front of the light receiving surface) and thereby detect the magneto-optical signals while regulation for servo signal detection is further facilitated.

Besides, since it is possible to execute an operation to give a wave front converting function or the like, for every branched light path, it is possible to guide the branched light beams from the four light branching portions 25a, 25b, 25c and 25d to the groups of light receiving portions 26a, 26b, 26c and 26d in the most suitable state, respectively.

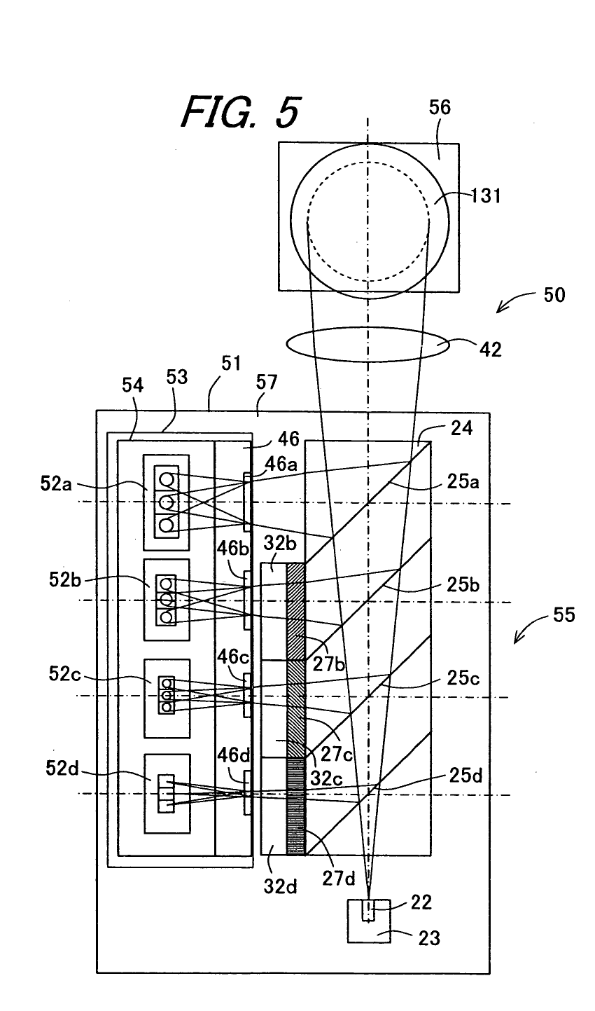

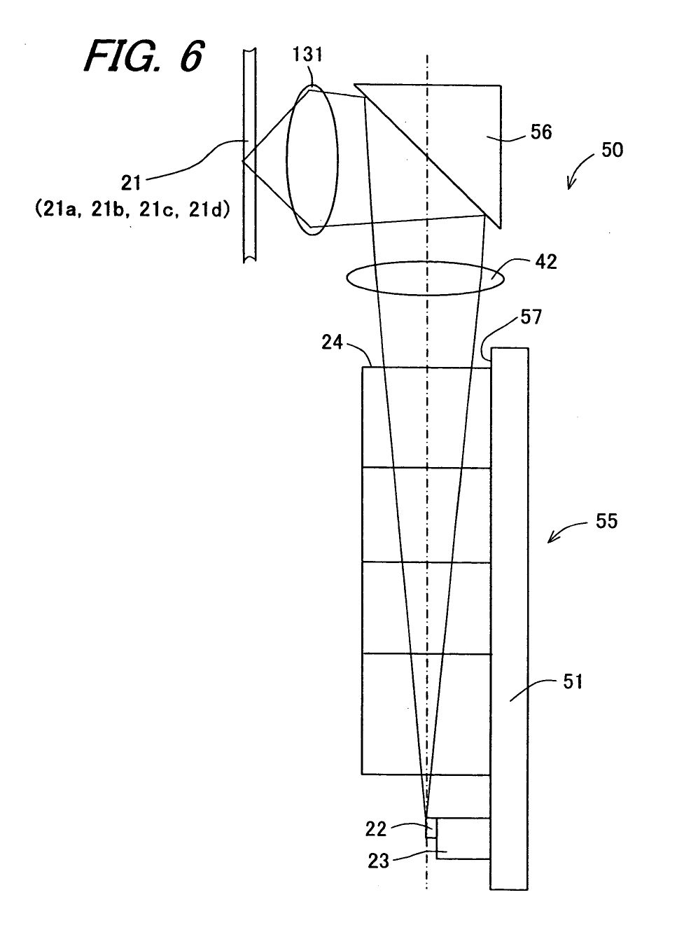

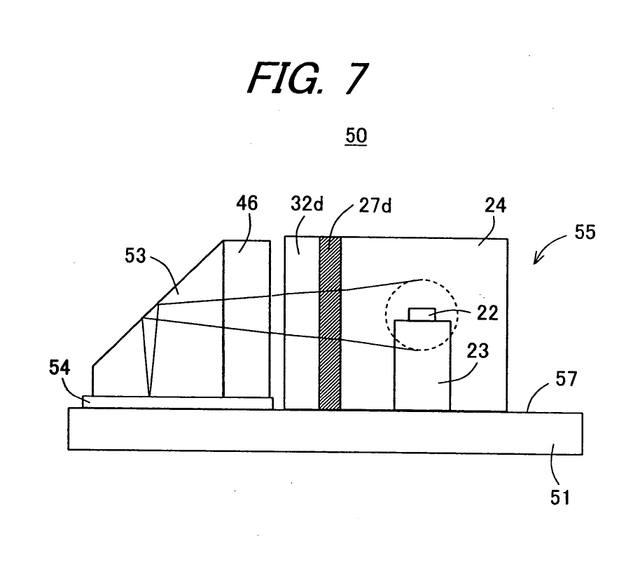

FIG. 5 is a simplified system diagram (plan view) showing a structure of an optical pickup 50 according to a fourth embodiment of the invention, FIG. 6 is a right side view of the optical pickup 50 shown in FIG. 5, and FIG. 7 is a downside view of the optical pickup 50 shown in FIG. 5. Since the optical pickup 50 of the embodiment is similar to the optical pickup 45 of the third embodiment, corresponding portions will be denoted by the same reference numerals and a description thereof will be omitted.

The optical pickup 50 further comprises a base portion 51 on which the light branching element 24 is mounted, the sub mount 23 on which the light source 22 is mounted, and at least one mirror portion 53. The at least one mirror portion 53 is placed on the four paths of the light beams branched by the four light branching portions 25a, 25b, 25c and 25d, and guides the four branched light beams to four groups of light receiving portions 52a, 52b, 52c and 52d. One surface 57 of the base portion 51 forms a reference surface 57 on which the sub mount 23, a light receiving device 54 composed by the four groups of light receiving portions 52a, 52b, 52c and 52d, and the mirror portion 53 are mounted.

In the optical pickup 50, the polarization split element 46 is securely disposed to the mirror portion 53, and the phase compensating elements 27b, 27c and 27d serving as the phase compensating means are securely disposed to the light branching element 24. Moreover, the sub mount 23 for supporting the light source 22, the light branching element 24, the phase compensating elements 27b, 27c and 27d, the polarization split element 46, the mirror portion 53, and the light receiving device 54 are mounted on the reference surface 57 of the base portion 51, whereby an integral optical block member 55 is structured.

In the optical pickup 50, the light beam emitted from the light source 22 is transmitted by the light branching element 24, transmitted and made to be of low NA by the semi-finite lens 42, reflected by another mirror portion 56 so that a light path thereof is bent almost 90 degrees, and thereafter, converged onto the information recording surface of the magneto-optical recording medium 21 by the objective lens 131.

The light beam reflected by the magneto-optical recording medium 21 is again transmitted by the objective lens 131, bent by the other mirror portion 56 and transmitted by the semi-finite lens 42, and thereafter, enters the light branching element 24. The light beam having entered the light branching element 24 is branched by the four light branching portions 25a, 25b, 25c and 25d, respectively. After four branched light beams generated by branching are polarization-split, respectively, by the four diffracting portions 46a, 46b, 46c and 46d of the polarization split element 46, light paths thereof are bent almost 90 degrees by the mirror portion 53, and the branched light beams are guided to the groups of light receiving portions 52a, 52b, 52c and 52d, and respectively received and detected by the groups of light receiving portions 52a, 52c and 52d each of which is divided in three and the light receiving group 52b which is divided in four.

In the optical pickup 50 of the embodiment, the light receiving device 54 is mounted on the reference surface 57 of the base portion 51. On the same reference surface 57 of the base portion 51, the light branching device 24, the mirror portion 53, and the sub mount 23 for supporting the light source 22 are mounted. Since the light source 22 via the sub mount 23, the light branching element 24, and the mirror portion 53 are placed on the same reference surface 57 of the base portion 51 in this manner, it is possible to guide and cause light beams to enter the groups of light receiving portions 52a, 52b, 52c and 52d, by using the light source 22 and the groups of light receiving portions 52a, 52b, 52c and 52d, and the mirror portion 53 that is the same reference surface for mounting as those of them, in the branched light paths for detecting servo signals.

Accordingly, it is possible to reduce factors in errors in an optical axis direction which are difficult to correct at the time of regulation, to factors restricted to an error in the shape of the sub mount 23, an error in the shape of the mirror portion 53, an error in the arrangement of the groups of light receiving portions 52a, 52b, 52c and 52d, and an error in the arrangement of the light source 22, with the result that it is possible to minimize errors in entering positions into the groups of light receiving portions 52a, 52b, 52c and 52d in the optical axis direction. This releases tolerance in the branched light paths for servo signal detection, and consequently releases a restriction on an optical design in other branched light paths.

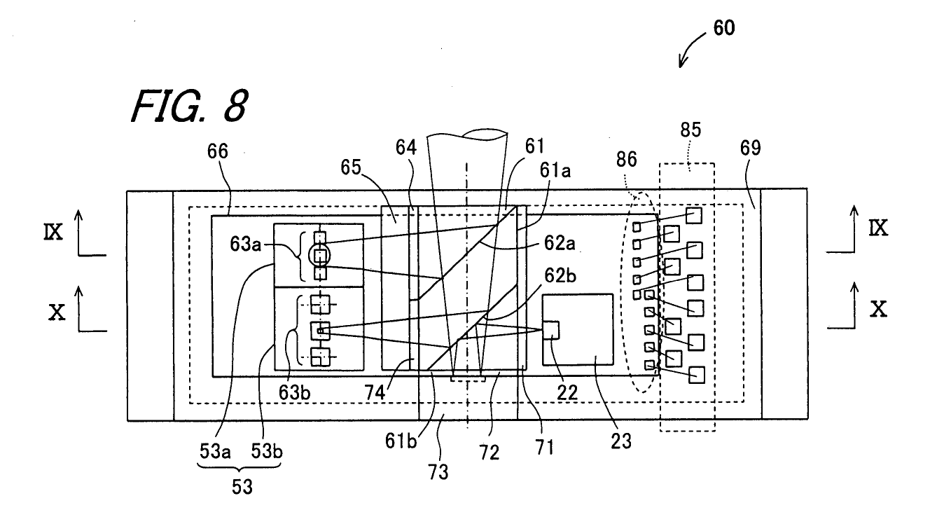

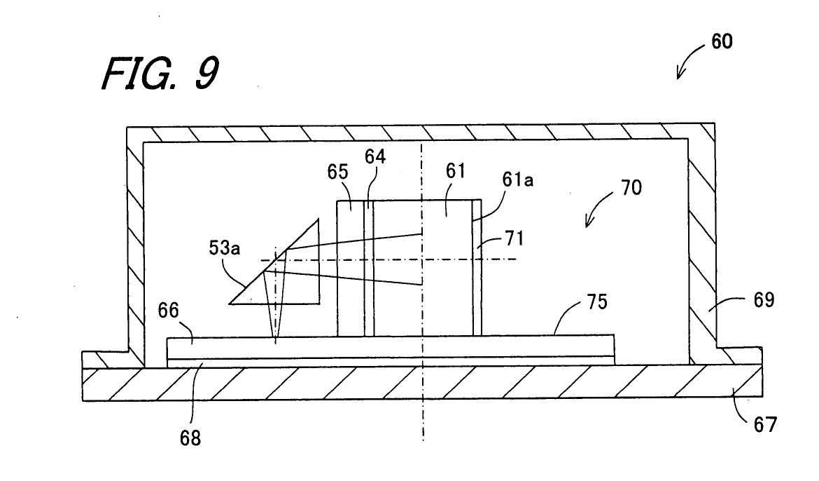

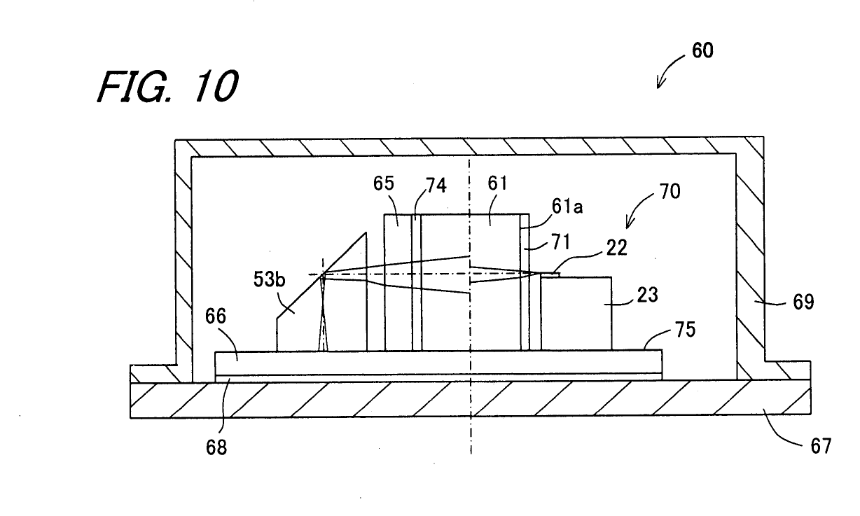

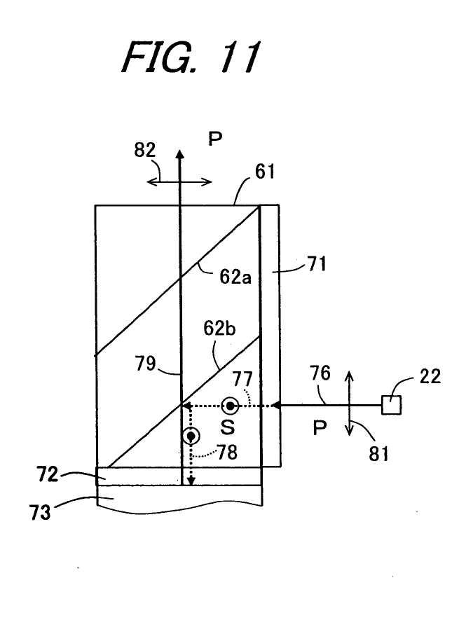

FIG. 8 is a simplified plan view showing a simplified structure of a light receiving and emitting unit 60 provided in an optical pickup according to a fifth embodiment of the invention, FIG. 9 is a cross sectional view taken on cutting plane line IX-IX of FIG. 8, and FIG. 10 is a cross sectional view taken on cutting plane line X-X of FIG. 8. Moreover, FIG. 11 is a view for explaining a light path in the light receiving and emitting unit 60. Since the optical pickup of the embodiment is similar to the optical pickup 50 of the fourth embodiment, the semi-finite lens 42, the objective lens 131 and the magneto-optical recording medium 21 having the same structures will not be shown in the drawings, corresponding portions will be denoted by the same reference numerals and a description thereof will be omitted.

The light receiving and emitting unit 60 provided in the optical pickup of the embodiment comprises a light branching element 61, two groups of light receiving portions 63a and 63b, phase compensating means 64, a polarization split element 65, a mirror portion 53, a light receiving device 66 and a unit base portion 67. The light branching element 61 has two light branching portions 62a and 62b for branching the light beam emitted from the light source 22 and reflected by the magneto-optical recording medium. The two groups of light receiving portions 63a and 63b respectively receive the light beams branched by the two light branching portions 62a and 62b. The phase compensating means 64 is placed on a path of the light beam branched by the first light branching portion 62a of the two light branching portions 62a and 62b, and provides the light beam branched by the first light branching portion with a fixed phase 61. The polarization split element 65 polarization-splits the light beams branched by the two light branching portions 62a and 62b so as to be used for detection of the magneto-optical signals. The mirror portion 53 is placed on the two paths of the light beams branched by the two light branching portions 62a and 62b and guides the branched light beams to the two groups of light receiving portions 63a and 63b. The light receiving device 66 in which the two groups of light receiving portions 63a and 63b are mounted on one substrate forms one base portion. The unit base portion 67 has a land portion for bonding the light receiving device 66 and the light source 22. Here, on the path of the light beam branched by the light branching portion 62b as well as between the light branching element 61 and the polarization split element 65, a spacer 74 for regulating a light path length is disposed. Moreover, the mirror portion 53 is composed of two mirror elements 53a and 53b so that distances between the light branching portions 62a and 62b and the groups of light receiving portions 63a and 63b vary. Here, the mirror portion 53 is not restricted to a shape as described above, and may have another shape such that the plural mirror elements 53a and 53b are placed separately.

As mentioned above, in the optical pickup of the embodiment, the light branching element 61 has two light branching portions 62a and 62b. Therefore, reproduction from two kinds of magneto-optical recording mediums is made by the optical pickup, and a phase difference between polarized light beams at the time of reproduction from the two kinds of magneto-optical recording mediums is generated only in one of the magneto-optical recording mediums, and reproduction light of the magneto-optical recording medium which causes the phase difference between polarized light beams passes through a region where the phase compensating means 64 is disposed, and reproduction light of the magneto-optical recording medium which does not generate the phase difference between polarized light beams passes through a region where the spacer 74 is disposed.

The light receiving and emitting unit 60 provided in the optical pickup of the embodiment is further characterized in that the light receiving and emitting unit 60, in which the light source 22 is placed so as to face the light branching portion 62b in the farthest position from the mounted magneto-optical recording medium, has a one-half (½) wavelength plate 71 disposed on a surface 61a of the light branching element 61 where a light beam emitted from the light source 22 toward the light branching portion 62b enters, a one-quarter (¼) wavelength plate 72 disposed on a surface 61b of the light branching element 61 so that a light beam emitted from the light source 22 and reflected by the light branching portion 62b is transmitted, and light reflecting means 73 which is disposed on an opposite side to the light branching element 61 with respect to the ¼ wavelength plate 72 and which reflects a light beam transmitted by the ¼ wavelength plate 72 and makes the light go back through the ¼ wavelength plate 72.

Further, the sub mount 23 for supporting the light source 22, the light branching element 61, the ½ wavelength plate 71 and the ¼ wavelength plate 72 mounted on the light branching element 61, the light reflecting means 73 securely disposed to the light branching element 61 via the ¼ wavelength plate 72, the phase compensating means 64 and the spacer 74 securely disposed to the light branching element 61, and the polarization split element 65 and the mirror portion 53 securely disposed to the light branching element 61 via the phase compensating means 64 and the spacer 74 are mounted on a reference surface 75 of the light receiving device 66 serving as a base portion, whereby an optical block member 70 is integrally structured. In the optical block member 70, a surface of the light receiving device 66, which is opposite to the reference surface 75, is fixed to the unit base portion 67 via a fixing member 68, and moreover, a protecting member 69 is mounted on the unit base portion 67 so as to cover the optical block member 70, whereby the light receiving and emitting unit 60 is structured. A bonding land portion 85 is formed on the unit base portion 67, and bonded to a bonding pad portion 86 formed on the light receiving device 66 by wires.

The phase compensating means 64 in the embodiment is a wavelength plate 64. As this wavelength plate, for example, in the case of a magneto-optical recording medium on a DWDD (DomainWall Displacement Detection) system to execute high-density recording and/or reproduction by magnetic domain wall movement, a λ/9 plate for phase compensation of 40 degrees is used. The polarization split element 65 is a polarizing hologram 65. In the optical block member 70, as described above, the wavelength plate 64 is securely disposed to the light branching element 61, and moreover, the polarizing hologram 65 is securely disposed to the light branching element 61 via the wavelength plate 64. In other words, the light branching element 61, the wavelength plate 64 and the polarizing hologram 65 are formed in one body.

Since the polarizing hologram 65 is securely disposed to the light branching element 61 in this manner, and thereby distances between positions where branched light beams are polarization-split and the groups of light receiving portions 63a and 63b can be secured long, it is possible to make a split angle at the time of polarization split to be relatively small.

Further, since the polarizing hologram 65 and the light branching element 61 are formed in one body, and thereby deviation of the split angle is hard to occur, it is possible to reduce the amount of regulation of rotation of the mirror 53 and the amount of regulation of parallel or vertical movement of the mirror 53 with respect to the optical axis, when making light beams from the branching portions enter the groups of light receiving portions 63a and 63b.

Further, since the light receiving device 66 serves as a base portion, and the reference surface 75 of the light receiving device 66 is defined as a common reference surface for mounting the sub mount 23, the light branching element 61, the mirror portion 53 and so on, it is possible to further reduce factors in errors in the optical axis direction at the time of making light beams enter the groups of light receiving portions 63a and 63b, to factors restricted to an error in the shape of the sub mount 23, an error in the shape of the mirror portion 53 and an error in the arrangement of the light source 22. Therefore, it is possible to further minimize the errors in the optical axis direction of the entering positions into the groups of light receiving portions 63a and 63b. Moreover, since the optical block member 70 is mounted on the unit base portion 67 and covered with the protecting member 69 to structure the light receiving and emitting unit 60, and thereby a major part of the apparatus is miniaturized, it is possible to reduce errors in the arrangement of each optical member.

Further, in the light receiving and emitting unit 60, the ½ wavelength plate 71 mounted on the light branching element 61, the ¼ wavelength plate 72 and the light reflecting means 73 are disposed as described above, whereby it is possible to place the light source 22 so that a direction that a light beam is emitted from the light source 22 and a direction where a light beam is emitted from the light receiving and emitting unit 60 toward the magneto-optical recording medium form an almost right angle. By placing in this manner, it is possible to extend the length of a light path on a way from the light source 22 to the light branching portion 62b, and it is possible to extend the lengths of light paths beams after branched by the light branching portions 62a and 62b and secure a margin for regulation between the polarizing hologram 65 and the mirror portion 53, and facilitate adjustment of light path lengths between a path of a light beam branched by the light branching portion 62a and a path of a light beam branched by the light branching portion 62b.

A light path from the light source 22 to the light branching portions 62a and 62b, and a light path that light beam from the light branching portions-62a and 62b exits from the light receiving and emitting unit 60, in the light receiving and emitting unit 60 will be described below referring to FIG. 11. First of all, a first light beam 76 emitted from the light source 22 toward the light branching element 61 (hereinafter, light beams of the respective light paths will be denoted by ranking in order to clearly distinguish for each light path) is a P-polarized light beam having a polarization direction in a direction of an arrow 81 in FIG. 11. The first light beam 76 passes through the ½ wavelength plate 71, thereby becoming a second light beam 77 of an S-polarized light beam whose polarization plane has been rotated 90 degrees, and enters the light branching element 61. The light branching-portion 62b of the light branching element 61 is provided with a polarizing film having a characteristic such that it transmits 90% of a P-polarized light beam and reflects 10% thereof and reflects 100% of an S-polarized light beam. Therefore, the second light beam 77 is reflected by the light branching portion 62b toward the ¼ wavelength plate 72, thereby becoming a third light beam 78.

The third light beam 78 passes through the ¼ wavelength plate 72, whereby a polarization plane thereof is circularly polarized, and further, the third light beam 78 is reflected while diffracted by a reflective diffracting element serving as the light reflecting means 73, and passes through the ¼ wavelength plate 72 again, thereby becoming a fourth light beam 79. Since the third light beam 78 passes through the ¼ wavelength plate 72 twice in a process of becoming the fourth light beam 79, the fourth light beam 79, whose polarization plane is rotated again, becomes a P-polarized light beam having a polarization direction in a direction of an arrow 82.

Since the light branching portion 62b transmits 90% of a P-polarized light beam, the fourth light beam 79 travels in a direction of exiting from the light receiving and emitting unit 60. The light branching portion 62a that the fourth light beam 79 passes through subsequently is provided with a polarizing film having a characteristic such that it transmits 90% of a P-polarized light beam and reflects 10% thereof and transmits 50% of an S-polarized light beam and reflects 50% thereof, and therefore, each of the polarizing films formed on the light branching portions 62a and 62b has an effect of Kerr rotation angle multiplication at the time of reproducing the magneto-optical signals.

Although the light reflecting means 73 is formed by the reflective diffracting element, it is not restricted to this, and it may be structured such that a simple mirror is disposed, or may be structured such that a light reflecting surface is directly formed on a surface of the ¼ wavelength plate 72. In the embodiment, the reflective diffracting element is used as the light reflecting means 73, a grating of the reflective diffracting element is used as a phase grating (a diffraction grating that light beams of plural phases coexist in diffraction light) to generate three beams, and detection of the tracking signal by the differential push-pull method is enabled. Consequently, it is possible to execute a stable tracking operation when reproducing either of two kinds of magneto-optical recording mediums having different track pitches.

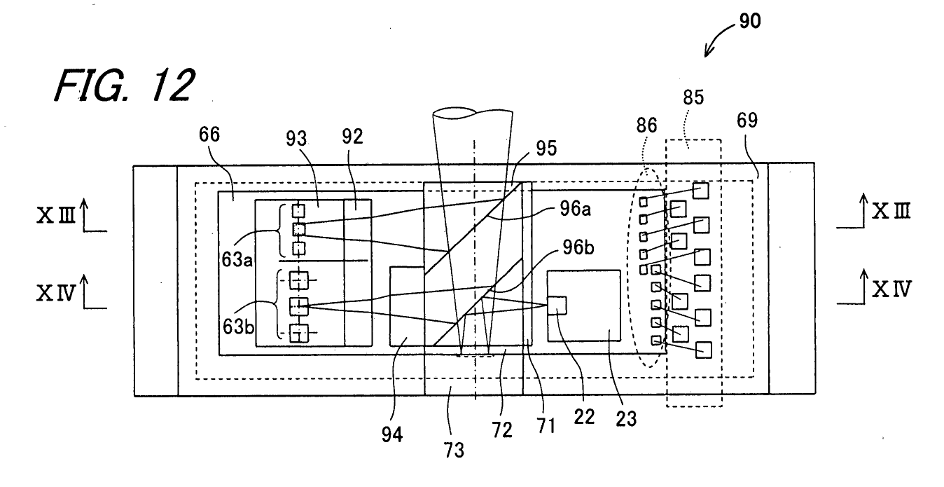

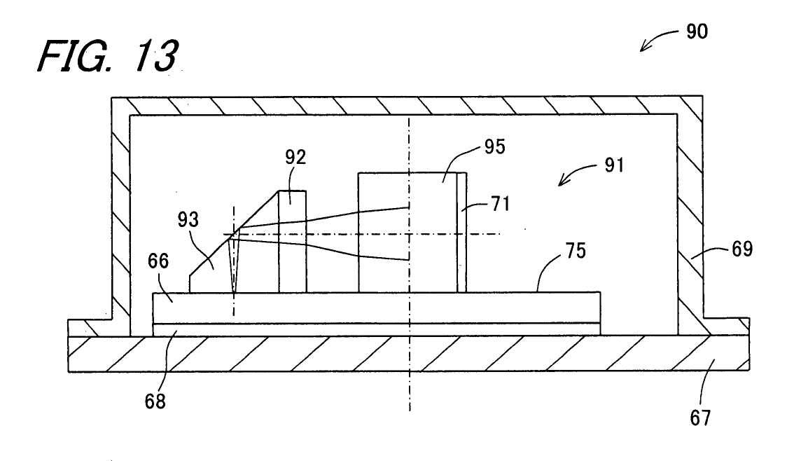

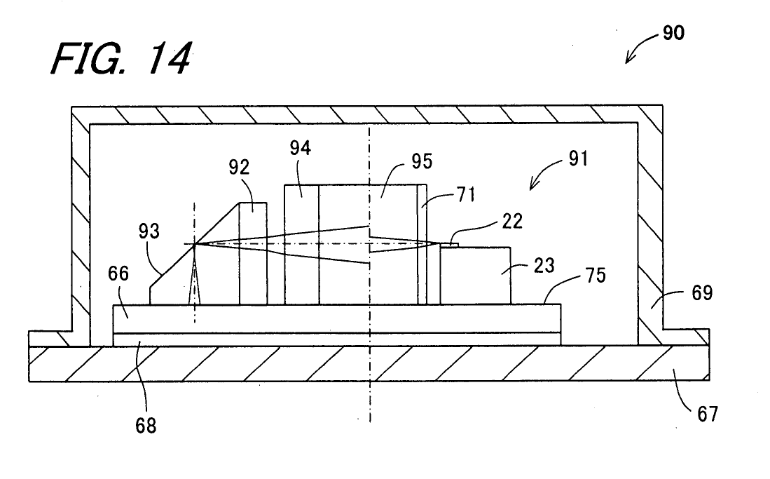

FIG. 12 is a simplified plan view showing a structure of a light receiving and emitting unit 90 provided in an optical pickup according to a sixth embodiment of the invention, FIG. 13 is a cross sectional view taken on cutting plane line XIII-XIII of FIG. 12, and FIG. 14 is a cross sectional view taken on cutting plane line XIV-XIV of FIG. 12. Since the light receiving and emitting unit 90 provided in the optical pickup of the embodiment is similar to the light receiving and emitting unit 60 provided in the optical pickup of the fifth embodiment, corresponding portions will be denoted by the same reference numerals and a description thereof will be omitted. The semi-finite lens 42, the objective lens 131 and the magneto-optical recording medium 21 of the optical pickup of the embodiment also have the same structures as those of the optical pickup of the fourth embodiment, and therefore, are not shown in the drawings.

What should be noted in the light receiving and emitting unit 90 provided in the optical pickup of the embodiment is that a polarization split element 92, which is a component member of an optical block member 91, is securely disposed to a mirror portion 93 and phase compensating means 94 is securely disposed to a light branching element 95. In the embodiment, the phase compensating means 94 is a wavelength plate 94, and the polarization split element 92 is a polarizing hologram 92. Since the wavelength plate 94 and the light branching element 95 are formed in one body and the mirror portion 93 and the polarizing hologram 92 are formed in one body, and thereby a relative polarization split angle can be changed by regulation of an angle accompanying regulation of a position of the mirror portion 93, it is possible to execute regulation of a position with respect to an angle by a smaller rotation angle. Accordingly, when regulating the servo signal, it is possible to efficiently suppress deformation of a spot at the time of mirror reflection by rotation of the mirror portion 93, for example, deformation such that the size increases.

In the optical pickup of the embodiment, the light branching element 95 has two light branching portions (96a, 96b) as in the optical pickup of the fifth embodiment. Therefore, the optical pickup reproduces from two kinds of magneto-optical recording mediums, a phase difference between polarized light beams at the time of reproduction from the two kinds of magneto-optical recording mediums is generated only in one of the magneto-optical recording mediums, and reproduction light from the magneto-optical recording medium that the phase difference between polarized light beams is generated passes through a region where the wavelength plate 94 serving as the phase compensating means is disposed.

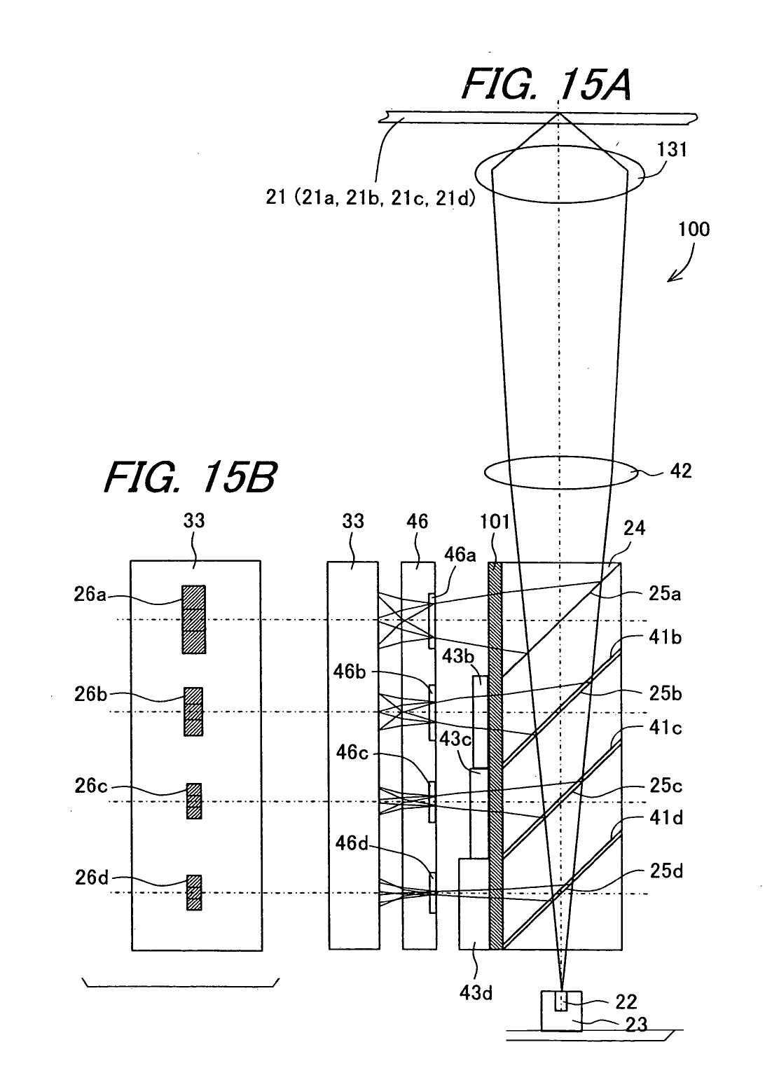

FIG. 15A is a simplified system diagram showing a structure of an optical pickup 100 according to a seventh embodiment of the invention. FIG. 15B is a front view of a light receiving device 33. Since the optical pickup 100 of the embodiment is similar to the optical pickup 40 of the second embodiment, corresponding portions will be denoted by the same reference numerals and a description thereof will be omitted.

For example, when polarizing films need to give δ1, δ2, δ3, δ4 (δ4=0) of phase differences between polarized light beams at the respective light branching portions as target values of phase differences, there is a case that it is impossible to set the phases given by the respective polarizing films to the above values with the design of the polarizing films because of transmissivity regulation between polarized light beams of the films. This results from that a phase difference and transmissivity have a strong relation in the film design. On the other hand, when values of δ′1 (=δ1−δ0), δ′2 (=δ2−δ0), δ′3 (=δ3−δ0), δ4 (=δ4−δ0=−δ0) (here, δ0 is a specified phase difference) are set to targets of phase differences between polarized light beams in the respective polarizing films, there is a case where it is possible to design the polarizing films. Here, by placing a phase compensating element which adds common phase compensation δ0 to light paths of the respective light branching portions, regarding phase differences between polarized light beams at the respective light branching portions, phase differences at the respective light branching portions become δ′1+δ0=δ1, δ′2+δ0=δ2, δ′3+δ0=δ3, δ′4+δ0=δ4 (δ4=0), and consequently reach the initial target values (δ1 to δ4 (δ4=0)). In other words, since phase compensation is executed in combination of the polarizing films and the phase compensating element, the degree of freedom of a set value of the phase compensation increases, and it is possible to more easily give the target phase differences to the respective light branching portions.

In the optical pickup 100, the polarization split element 46 made by the polarizing hologram used in the optical pickup 45 of the third embodiment is used as the polarization split element, and the respective diffraction gratings of the four diffracting portions 46a, 46b, 46c and 46d of the polarization split element 46 are determined to have different diffraction characteristics from each other.

In FIG. 15A, the isotropic glass members 43b, 43c and 43d serving as spacers for light path compensation are attached on a side of a phase compensating element 101, and have a function in changing a spot size on the light receiving portion for every branch light path, so that it is possible to easily reduce the spot size on the light receiving portion to a specified size.

Further, when structured to have the polarizing hologram as the polarization split element, the phase compensating element for adding the phase compensation δ0 can be easily integrated on the polarizing hologram side. In this case, it is possible to execute regulation of the spot size on the light receiving portion by providing the hologram itself with a wave front converting function and using the polarizing hologram, without using the isotropic glass members 43b, 43c and 43d.

Therefore, although two phase compensating means of the polarizing films and the phase compensating element are provided, it is possible to detect polarization split while executing aimed phase compensation without increasing the number of structural elements.

Thus, the optical pickup 100 can realize phase compensation which can respond to plural kinds of magneto-optical recording mediums, without adding a component member other than the polarizing films 41b, 41c and 41d disposed to the light branching portions 25b, 25c and 25d and the phase compensating element 101 commonly disposed on all the paths of the light beams branched by the light branching element 24.

Further, in the optical pickup 20, 40, 45, 50 and 100, reflectance of each of the light branching portions 25a, 25b, 25c and 25d may be set by weighting in accordance with a modulation factor or a signal output level of a magneto-optical signal detected in the path of light beams branched by each of the light branching portions 25a, 25b, 25c and 25d. That is to say, it is possible to determine reflectance for every branch light path, in consideration of the sizes of the light receiving portions for receiving light beams branched by the light branching portions 25a, 25b, 25c and 25d, or the modulation factors of the magneto-optical signals detected in systems branched by the light branching portions 25a, 25b, 25c and 25d.

For example, in a state where the sizes of the light receiving portions composing the respective groups of light receiving portions are equal, it is preferable to place the light branching portions 25a, 25b, 25c and 25d in a manner that a light branching portion closer to the magneto-optical recording medium 21 is more suitable for detection of a magneto-optical signal of the magneto-optical recording medium 21 for which increase of the light amount at the time of signal reproduction is more favorable. That is to say, it is desirable to place in a manner that transmissivity becomes larger in an order from the light branching portion 25a to the light branching portion 25d.

On the contrary, in cases where the sizes of the light receiving portions corresponding to the light branching portions 25a, 25b, 25c and 25d become smaller in an order from the light branching portion 25d on the far side to the light branching portion 25a on the near side with respect to the magneto-optical recording medium 21, it is better to set reflectance by weighting, however, a difference in reflectance between the light branching portions is set to be small.

Accordingly, it is possible to determine reflectance by taking it into account whether it is a branched light path which can increase the quality of the magneto-optical signal by positional regulation though the size of the light receiving portion composing the group of light receiving portions is small, or whether it is a branched light path that the size of the light receiving portions composing the group of light receiving portions is increased for error absorption in regulation, with the result that it is possible to obtain a better condition for magneto-optical signal reproduction. Moreover, when using a branched light path with low reflectance for signal detection of a magneto-optical recording medium whose reproduction power is small, it is also possible to compensate for decrease of reflectance by increasing the light amount of the light source.

As described above, in the embodiment, the number of the light branching portions provided in the light branching element is two or four, however, it is not restricted to the aforementioned numbers, and may be three or five or more.

The invention may be embodied in other specific forms without departing from the spirit or essential characteristics thereof. The embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An optical pickup for recording information on N kinds of magneto-optical recording mediums which have an information recording layer formed of multiple films and in which phase differences between polarized light beams caused at the time of signal reproduction are different from each other and/or reproducing information from the magneto-optical recording mediums, the optical pickup comprising:
a light source for emitting a light beam;
a light branching element for branching the light beam emitted from the light source and reflected by the magneto-optical recording medium, the light branching element having N light branching portions;
N groups of light receiving portions for receiving the light beams branched by the N light branching portions;
(N−1) phase compensating means which are placed on paths of light beams branched by, of the N light branching portions, remaining (N−1) light branching portions excluding an i-th light branching portion, and which provides a light beam branched by an M-th light branching portion (M=1, 2, . . . i−1, i+1, . . . N) of the remaining (N−1) light branching portions with a fixed phase δM; and
at least one polarization split element for polarization-splitting the light beams branched by the N light branching portions so as to be used for magneto-optical signal detection,
wherein servo signals of the N kinds of magneto-optical recording mediums are respectively detected by the use of light beams detected by (N−1) or less groups of light receiving portions.

2. The optical pickup of claim 1, wherein the phase compensating means is at least one of a phase compensating element and a polarizing film which is disposed to the light branching portion.

3. The optical pickup of claim 3, further comprising a fixed phase compensating element which, when giving a specified fixed phase δM (M=1, 2, . . . j−1, j+1, . . . N) in the M-th branched light path of the N branched light paths, sets a difference (δM−δj) obtained by using a j-th fixed phase difference δj as a reference value, as a fixed phase, gives the fixed phase (δM−δj) to the polarizing films of all the branched light paths excluding a j-th branched light path, gives a fixed phase (−δj) in the j-th branched light path, extends over all the branched light paths, and gives a fixed phase δj.

4. The optical pickup of claim 1, wherein reflectance that each of the N light branching portions reflects for branching light is set by weighting in accordance with a modulation factor or a signal output level of a magneto-optical signal detected in each of the branched light paths of the N light branching portions.

5. The optical pickup of claim 2, wherein reflectance that each of the N light branching portions reflects for branching light is set by weighting in accordance with a modulation factor or a signal output level of a magneto-optical signal detected in each of the branched light paths of the N light branching portions.

6. The optical pickup of claim 3, wherein reflectance that each of the N light branching portions reflects for branching light is set by weighting in accordance with a modulation factor or a signal output level of a magneto-optical signal detected in each of the branched light paths of the N light branching portions.

7. The optical pickup of claim 1, wherein the polarization split element is a diffracting element which has a plurality of diffracting portions and whose diffraction efficiency changes depending on a polarized light beam, and
the polarization split element is placed so as to extend over two or more branched light paths of the paths of the light beams branched by the N light branching portions, and so as to exist between the M-th phase compensating means and the M-th group of light receiving portions in the path of the light beam branched by the M-th light branching portion.

8. The optical pickup of claim 1, further comprising:
a base portion on which the light branching element is mounted;
a sub mount portion on which the light source is mounted; and
at least one mirror portion which locates on the N paths of the light beams branched by the N light branching portions and guides the N branched light beams to the N groups of light receiving portions,
wherein one surface of the base portion forms a reference surface on which the sub mount portion, the N groups of light receiving portions and the mirror portion are mounted.

9. The optical pickup of claim 8, wherein the base portion is one light receiving device composed of the N groups of light receiving portions.

10. The optical pickup of claim 9, wherein the polarization split element and the phase compensating means are securely disposed to the light branching element, and the light source, the sub mount, the light branching element, the polarization split element, the mirror portion and the phase compensating means are mounted on the base portion, whereby an integral optical block member is structured.

11. The optical pickup of claim 8, wherein the polarization split element is securely disposed to the mirror portion, the phase compensating means is securely disposed to the light branching element, and the light source, the sub mount, the light branching element, the polarization split element, the mirror portion and the phase compensating means are mounted on the base portion, whereby an integral optical block member is structured.

12. The optical pickup of claim 9, wherein the polarization split element is securely disposed to the mirror portion, the phase compensating means is securely disposed to the light branching element, and the light source, the sub mount, the light branching element, the polarization split element, the mirror portion and the phase compensating means are mounted on the base portion, whereby an integral optical block member is structured.

13. The optical pickup of claim 10, further comprising:
a unit base portion which has a land portion for bonding the light receiving device and the light source;
a fixing member which fixes the optical block member to the unit base portion; and
a protecting member which covers the optical block member,
wherein the optical block member, the unit base portion, the fixing member and the protecting member compose a light receiving and emitting unit.

14. The optical pickup of claim 12, further comprising:
a unit base portion which has a land portion for bonding the light receiving device and the light source;
a fixing member which fixes the optical block member to the unit base portion; and
a protecting member which covers the optical block member,
wherein the optical block member, the unit base portion, the fixing member and the protecting member compose a light receiving and emitting unit.

15. The optical pickup of claim 1, further comprising:
a one-half wavelength plate which is disposed on a surface of the light branching element that a light beam emitted from the light source toward the light branching portion enters, the light source being placed so as to face the light branching portion locating in the farthest position from the mounted magneto-optical recording medium;
a one-quarter wavelength plate which is disposed on a surface of the light branching element so that a light beam emitted from the light source and reflected by the light branching portion passes through; and
light reflecting means which is disposed on the opposite side to the light branching element across the one-quarter wavelength plate, and which reflects light having passed through the one-quarter wavelength plate and causes the light to pass through the one-quarter wavelength plate back.
